(19) United States
(12) Patent Application Publication
(10) Pub. No.: US 2008/0021957 A1
(43) Pub. Date: Jan. 24, 2008

(54) PUSHED MEDIA CONTENT DELIVERY

(76) Inventors: Jonathan William Medved, Jerusalem (IL); David Elliot Goldfarb, Beit Shemesh (IL)

Correspondence Address: DANIEL J SWIRSKY, 55 REUVEN ST., BEIT SHEMESH, 99544, omitted

(21) Appl. No.: 11/775,249

(22) Filed: Jul. 10, 2007

Related U.S. Application Data
(60) Provisional application No. 60/819,393, filed on Jul. 10, 2006.
(60) Provisional application No. 60/830,354, filed on Jul. 13, 2006.
(60) Provisional application No. 60/885,425, filed on Jan. 18, 2007.
(60) Provisional application No. 60/895,524, filed on Mar. 19, 2007.

(51) Int. Cl. G06F 15/16; G06F 7/00; G06F 3/00

(52) U.S. Cl. 709/203; 715/716; 709/206; 707/100

(57) ABSTRACT

A method includes playing a media clip in association with call-related activities, notifying a user that associated media content is available, and enabling the user to play the associated media content. Another method includes storing an informational announcement on mobile devices and activating said informational announcement in association with call-related activities. Another method includes providing a game to mobile devices and activating the game in association with call-related activities.

### CROSS-REFERENCE TO RELATED APPLICATIONS

This application claims benefit from U.S. Provisional Patent Application No. 60/819,393, filed Jul. 10, 2006, U.S. Provisional Patent Application No. 60/830,354, filed Jul. 13, 2006, U.S. Provisional Patent Application No. 60/885,425, filed Jan. 13, 2007, and U.S. Provisional Patent Application No. 60/895,524, filed Mar. 19, 2007, all of which are hereby incorporated in their entirety by reference.

### FIELD OF THE INVENTION

The present invention relates to cellular telephones generally and to the distribution of shared personalization content in particular.

### BACKGROUND OF THE INVENTION

Call related audio tones are known in the art. For example, a ringtone is a sound played on a phone handset, e.g. on a mobile cellular phone, to announce an incoming phone call. A ringtone is typically selected by the user of the phone receiving the call. A ringback tone is a sound played on a phone handset when calling another phone. Typically, the tone is chosen by the owner of the dialed phone. A “ringbye” tone is a sound played at the end of a phone conversation and is typically selected by one of the conversation's participants.

Other types of call-related tones include video ringtones, video ringback tones and video ringbye tones, each of which use video clips rather than audio sounds. U.S. patent application Ser. No. 11/544,938, which is hereby incorporated in its entirety by reference, discloses a variety of other video and audio call related tones that are triggered by various events including: call initiation, call ringing, end of call, a busy signal, a “fast busy” signal, or a call waiting signal.

FIG. 1, to which reference is now made, illustrates a media content sharing system 100 described in prior patent applications U.S. 60/771,883 and 60/772,564, now incorporated into U.S. Ser. No. 11/544,938, assigned to the common assignee of the present application and incorporated herein by reference. When the content is video ringtones, the video ringtone chosen by the calling party is displayed on the called handset.

FIG. 1 shows a communication device 110, owned, for example, by Jack, and a telephone 120, owned, for example, by Jill, who are setting up or using a voice connection 140 for a telephone conversation. Jack and Jill are members of a content-sharing community 150 and use a community server 130 for the selection and download of content, such as video clips, to be played on communication device 110. In the example, Jack and Jill are also “buddies”, members of community 150 who elect to share content with each other.

Community server 130 comprises a video clip database 132 which stores a collection of video clips 234 for selection by members of community 150. Jill accesses community server 130 via an Internet connection (arrow 131) and then selects a video clip 234 for her video ringtone.

A software client (not shown) on Jack's communication device 110 then downloads (arrow 133) Jill's video clip 234 to device 110. Communication device 110 comprises a media player 112, a personalization content manager 137, and buddy media clip database 138. Buddy media clip database 138 stores media clips 134 which are copied versions of media clips 234 selected by Jack's buddies.

When Jill initiates a voice connection 140 from telephone 120 to Jack's communication device 110, personalization content manager 137 identifies her as one of Jack's buddies. Personalization content manager 137 then retrieves the media clip 134 originally selected by Jill and plays it as a video ringtone on media player 112, thus playing Jill's selected clip on Jack's phone when Jill calls.

Community 150 is also used in a similar manner to download other variations of video ringtones. For example, Jill can select a media clip 234 for a video ringback tone as well. After the selected video clip 234 is downloaded to Jack's device 110, it can be played as a video ringback tone when he calls Jill. Jack and Jill can also select media clips 234 for video bye tones as well.

U.S. patent application Ser. No. 11/544,938 also discloses a variety of other call-related media tones that are triggered by various events including: call initiation, call ringing, end of call, a busy signal, a “fast busy” signal, or a call waiting signal. U.S. patent application Ser. No. 11/544,938 further describes how such call-related media tones apply to non-telephonic environments. For example, such media tones can also be implemented within an instant messaging (IM) environment.

### SUMMARY OF THE PRESENT INVENTION

There is provided, in accordance with a preferred embodiment of the present invention, a method including playing a media clip in association with call-related activities, notifying a user that associated media content is available and enabling the user to play the associated media content.

Additionally, in accordance with a preferred embodiment of the present invention, the method includes downloading the associated media content prior to the playing of the media content. Alternatively, in accordance with a preferred embodiment of the present invention, the method includes downloading the associated media content after the notifying.

Moreover, in accordance with a preferred embodiment of the present invention, the notifying includes at least one of the following: sending an email, sending an SMS, sending an MMS, sending a message, invoking a dedicated application, displaying text, and playing another media clip.

Further, in accordance with a preferred embodiment of the present invention, the enabling includes providing a user interface element to play the associated mobile content.

Still further, in accordance with a preferred embodiment of the present invention, the user interface element is embedded within the media clip.

Moreover, in accordance with a preferred embodiment of the present invention, the enabling includes providing instructions how to play the associated media content.

Alternatively, in accordance with a preferred embodiment of the present invention, the enabling includes providing means to play the associated mobile content following the playing of the media clip.

Alternatively, in accordance with a preferred embodiment of the present invention, the enabling includes providing means to access and play the associated mobile content and/or the media clip at a later time.

Further, in accordance with a preferred embodiment of the present invention, the associated media content may be from a subscription service or a different source than the media content.

Still further, in accordance with a preferred embodiment of the present invention, the associated media content may be an advertisement, a news report and/or a game.

There is also provided, in accordance with a preferred embodiment of the present invention, a system including a community server, an associator and a downloader. The community server stores media clips for playing on communications devices on the occasions of call related activity. The associator stores associations of the media clips with media content and the downloader provides the associations and the media clips to the communications devices.

Additionally, in accordance with a preferred embodiment of the present invention, the downloader includes a unit for downloading the associated content.

Further, in accordance with a preferred embodiment of the present invention, the downloader includes a unit for providing a reference from which the associated media content can be accessed.

Still further, in accordance with a preferred embodiment of the present invention, the media clips are advertisements, news reports and/or games.

There is also provided, in accordance with a preferred embodiment of the present invention, a method including storing an informational announcement on mobile devices and activating the informational announcement in association with call-related activities.

Moreover, in accordance with a preferred embodiment of the present invention, the informational announcement is an advertisement or a news report and may be in the form of a media clip, a text message, an MMS, an application and a hyperlink.

Further, in accordance with a preferred embodiment of the present invention, the method also includes notifying a user that media content associated with the informational announcement is available.

Still further, in accordance with a preferred embodiment of the present invention, the method also includes downloading the associated media content prior to the activating.

Alternatively, in accordance with a preferred embodiment of the present invention, the method also includes downloading the associated media content subsequent to the activating.

Moreover, in accordance with a preferred embodiment of the present invention, the method also includes enabling the user to play the associated media content.

There is also provided, in accordance with a preferred embodiment of the present invention, a method including providing a game to mobile devices and activating the game in association with call-related activities.

Moreover, in accordance with a preferred embodiment of the present invention, the game may be a media clip, an MMS, a text message or a game application. The game may be a single player game or a multiplayer game.

Further, in accordance with a preferred embodiment of the present invention, the method also includes using a data channel to exchange game data between players of the multiplayer game and enabling the players to converse over a voice channel.

Still further, in accordance with a preferred embodiment of the present invention, the method also includes using a standalone version of the multiplayer game for each player and enabling the players to converse over a voice channel.

There is also provided, in accordance with a preferred embodiment of the present invention, a system including a media player and a notifier. The media player plays at least one media clip in response to call-related activity between a user and a buddy. The notifier notifies the user that media content associated with the media clip is available.

Additionally, in accordance with a preferred embodiment of the present invention, the system also includes a downloader to download the media clips and the associated media content.

Moreover, in accordance with a preferred embodiment of the present invention, the media player also plays the associated media content.

Finally, in accordance with a preferred embodiment of the present invention, the system also includes a personalization content manager to access the media clip and the associated media content.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a media content sharing system for the selection and distribution of media content, such as video ringtones;

FIG. 2 is a schematic illustration of a pushed media content delivery system, constructed and operative in accordance with the present invention;

FIGS. 3 and 4 are schematic illustrations of alternative pushed media content delivery systems, constructed and operative in accordance with preferred embodiments of the present invention; and

FIG. 5 is a schematic illustration of a game system that uses the system of FIG. 1 for dissemination to its players.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that media content sharing system 100 may provide an infrastructure for pushing media content to members of community 150 for their use in other contexts in addition to that of call or session related media tones. For example, a user may download a given video clip 234 as selected by a buddy for use as a video ringtone. However, after viewing video clip 134 during the first subsequent call received from the buddy, the user may later elect to play video clip 134 as a standalone clip without waiting for the next phone conversation to take place.

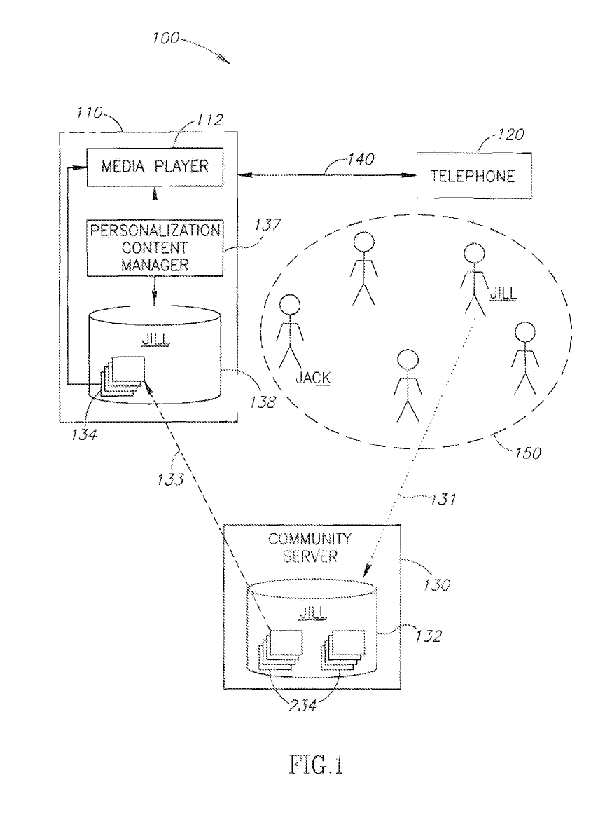

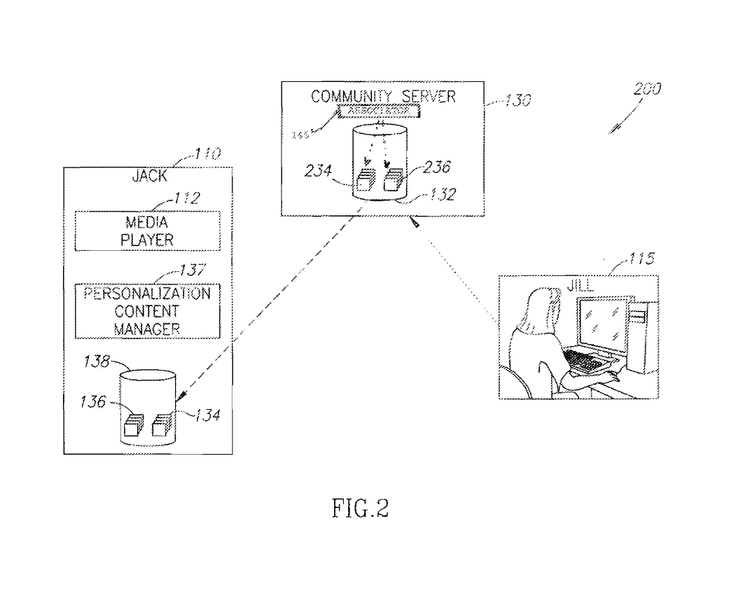

FIG. 2, to which reference is now made, illustrates a novel system 200 for the pushing of media tone content to be shared with other users, such as members of community 150 (FIG. 1). Typically, the media clips may be used as call-related video tones, such a ringtone, a ringback tone, a ringbye tone, and/or when the call cannot be completed (busy or call-waiting). The media clips may also be available for the other users to view at their own initiative.

System 200 may comprise a community server 130, a personal computer 115 belonging to a user named Jill, and a communications device 110 belonging to Jill's buddy, Jack. Jack and Jill may be members of community 150 (FIG. 1). A communications network (not shown), such as the Internet, may be used to exchange data between the elements of system 200.

As in the prior art, community server 130 may comprise clip database 132 in which media clips 234 may be stored. However, in accordance with a preferred embodiment of the present invention, clip database 132 may also store media content 236. It will be appreciated that a multiplicity of media clips 234 and media content 236 may be stored by clip database 132. However, in the interests of clarity only one of each type is represented in FIG. 2.

In accordance with a preferred embodiment of the present invention, community server 130 may also comprise an associator 145 which may be used to associate media content 236 with media clips 234.

For example, Jill may use personal computer 115 to access community server 130 and select a media clip 234 for use with her buddy, Jack. Jill may also use associator 145 to associate media content 236 with media clip 234. Media content 236 may typically be an expanded version of a media clip 234. For example, media clip 234 may be a fifteen second excerpt from a song, whereas media content 236 may be the original song in its entirety.

In accordance with an alternative preferred embodiment of the present invention, media content 236 may have already been associated with media clip 234 when it was initially loaded onto community server 130. In accordance with another alternative preferred embodiment of the present invention, media clip 234 may have been automatically generated from associated media content 236 by community server 130 or by another service. Such automatic generation may derive media clip 234 as a “reduced” version of associated media content 236. For example, associated media content 236 might be a full video clip while media clip 234 might be silent; media clip 234 might comprise a series of still frames extracted from associated media content 236; or media clip 234 might comprise a single frame.

As described in U.S. patent application Ser. No. 11/544,938, media clip 234 may be downloaded as media clip 134 to communications device 110, typically for use as call-related media tones. However, in accordance with a preferred embodiment of the present invention, associated media content 236 may also be downloaded as media content 136.

As in the prior art, communications device 110 may comprise a media player 112, a personalization content manager 137, and a buddy media clip database 138 in which media clip 134 may be stored. In accordance with a preferred embodiment of the present invention, buddy media clip database 138 may also store associated media content 136. Personalization content manager 137 may track and maintain associations between media clips 134 and associated media content 136.

Media clips 134 may be played by media player 112 in association with call-related activities. For example, media clip 134 may be used as a video ringtone, a video ringback tone, or a video ringbye tone during a conversation between Jack and Jill. Before, during and/or after the playing of the media tone, personalization content manager 137 may send a message to the user indicating that associated media content 136 may also be available to be played. Such a message may also include instructions regarding how to play associated media content 136.

The message may be sent via SMS, MMS, or email, or any other suitable messaging medium, including simple audible or visual display. The message may also be included in a dedicated application or embedded in an add-on media clip that may be run or played immediately after media clip 134. In accordance with an alternative preferred embodiment of the present invention, the message may be embedded in media clip 134.

The message may include a user interface element or a “trigger” for launching media player 112 to play media content 136. Jack may elect to play associated media clip 136 immediately, or may decide to do so at a later time. It will be appreciated that whether or not a trigger may be embedded in media clip 134 may be a function of the capabilities of media player 112. For example, media clip 134 may be browser-compatible and the trigger may be a link embedded in the file.

In accordance with an alternative embodiment of the present invention, the message may just inform Jack that media content 136 is available without providing a trigger for immediate play. Jack may proactively play media content 136 by accessing it through the built-in utilities found on communications device 110, or by accessing it through personalization content manager 137.

It will be appreciated that system 200 provides a new and novel system for a “push delivery” of media content to a user. In such systems, media content may be “pushed” to a customer on a regular basis without requiring any proactive requests by the customer. Such systems typically use email or SMS to notify the customer when a delivery has been made. Such notification methods may be problematic, as there may be no guarantee that a user will actually see or read the notice. Even if the user sees the notices, they may arrive at an inopportune time and may soon be forgotten. System 200, however, may provide notification in a more successful manner, which may increase the likelihood that the user may actually play the delivered media content.

It may not be feasible to download associated media content 136 prior to the playing of media clip 134. Media content 136 may be very large and/or Jack may have several buddies, each having selected a different media clip 134. It may be impractical to store all currently relevant media content 136 on communications device 110.

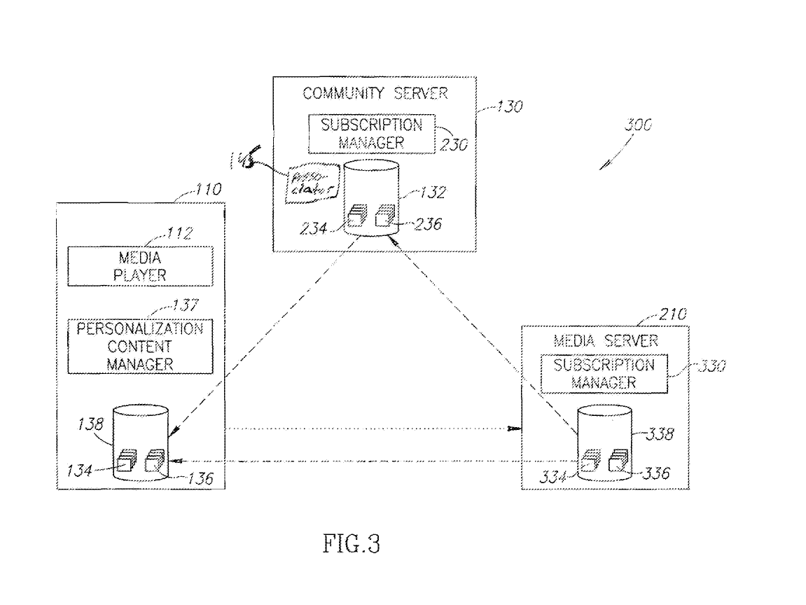

Therefore in accordance with an alternative preferred embodiment of the present invention, an associated media content 236 may be downloaded or streamed in response to a notification associated with a media clip 134. FIG. 3, to which reference is now made, illustrates a system 300, similar to system 200, which may enable the download and/or play of associated media content 236 after 134 media clip is played on communications device 110. Similar reference numerals in FIG. 3 refer to similar objects.

System 300 may comprise community server 130, communications device 110 and a media server 210. As in the previous embodiment, media clip 234 may be downloaded to communications device 110 and stored as media clip 134 in media clip database 138. However, associated media content 236 may not be downloaded at the same time.

Media player 112 may play media clip 134 in response to a call related activity, and a notification regarding an associated media content 236 available for download may be embedded in media clip 134 or generated by personalization content manager 137. The notification may comprise a trigger to download associated media content 236. Activation of the trigger may cause communications device 110 to connect to community server 130 and download associated media content 236; storing it as associated media content 136 in media content database 138. In accordance with an alternative embodiment of the present invention, associated media content 236 may be “streamed” directly to media player 112 without saving it first in database 138.

It may be impractical to continually store all of associated media content 236 for community 150 on community server 130. For example, there may not be enough storage on community server 130 to store all of the associated media content 236 for every member of community 150. Associated media content 236 may also be provided by sources external to the operator of community server 130. Accordingly, associated media content 236 may also not be stored on community server 130.

In accordance with an alternative preferred embodiment of the present invention, associated media content 236 may also be stored on media server 210 as associated media content 336. When community server 130 receives a request to download associated media content 236 to communications device 110 it may initiate a connection with media server 210 to download associated media content 336 to database 132, where it may be stored as associated media content 236. Associated media content 236 may then be downloaded to communications device 110. It will be appreciated that media server 210 is a logical unit; it may be located on the same physical device as community server 130 or on a separate device.

In accordance with another alternative preferred embodiment of the present invention, the download process may be streamlined by enabling communications device 110 to connect directly to media server 210. Associated media content 336 may be downloaded and played on communications device 110 without an intermediate download to community server 130. It will be appreciated that a trigger and/or connection instructions may be provided as part of the notification process to enable such a connection to be effected between communications device 110 and media server 210.

Applicants have realized that system 300 may also be used by subscription services to market and distribute media content. Media server 210 may comprise a subscription manager 330, an inventory of media clips 334, and associated media content 336 available for distribution by subscription manager 330. Instead of selecting media clips 234 from community server 130, members of community 150 may access subscription manager 330 and may select media clips 334 from media server 210. As in the previous embodiment, associated media content 336 may be downloaded to communication device 110 after media clip 134 is played and the associated notification is received. In accordance with an alternative embodiment of the present invention, associated media content 336 may also be downloaded to communications device 110 at the same time as media clips 334.

In another alternative preferred embodiment of the present invention, subscription manager 330 may select media clips 334 on behalf of its subscribers from among members of community 150. Subscription manager 330 may also proactively change the selections of media clips 334 from time to time. It will be appreciated that such changes may expose the members of community to new opportunities to download associated media content 336.

Furthermore, subscription manager 330 may also replace associated media content 336 for a given media clip 334. For example, a media clip 334 may comprise a video of the opening montage of a television series. Associated media content 336 may comprise an entire episode of the series; each week subscription manager 330 may switch the association to the most recent episode of the series.

It will be appreciated that system 300 may be configured to include the functionality of subscription manager 330 in community server 130. In accordance with an alternative preferred embodiment of the present invention, subscription manager 230 may be included as a component of community server 130. Subscription manager 230 may provide subscription services in a manner similar to that of subscription manager 330; using media clips 234 and associated media content 236 instead of media clips 334 and associated media content 336. Furthermore, in accordance with another preferred embodiment of the present invention, subscription manager 230 may also manage subscription services for media clips 334 and associated media content 336 stored on media server 210.

Applicants have realized that the present invention may also be used to distribute informational announcements, such as news updates. In accordance with a preferred embodiment of the present invention, media clip 134 may comprise a short news item in text, audio or video form. Media content 336 may comprise an expanded article to be accessed and/or downloaded after media player 110 plays media clip 134. As described hereinabove, subscription manager 330 may proactively change the selections of media clip 334 from time to time in order to present different news items as they become of interest. Similarly, subscription manager 330 may switch associated media content 336 as a news story develops. It will be appreciated that subscription manager 230 may also manage news update subscriptions in a similar manner.

In accordance with an alternative preferred embodiment of the present invention, subscription managers 230 and 330 may not provide associated media content 236 and 336. Instead, the trigger may comprise a link to a URL outside of system 300. The external link may access, for example, a page on a news site that may be constantly updated with an ongoing story. Alternatively, the external link may access a page with a list of current stories.

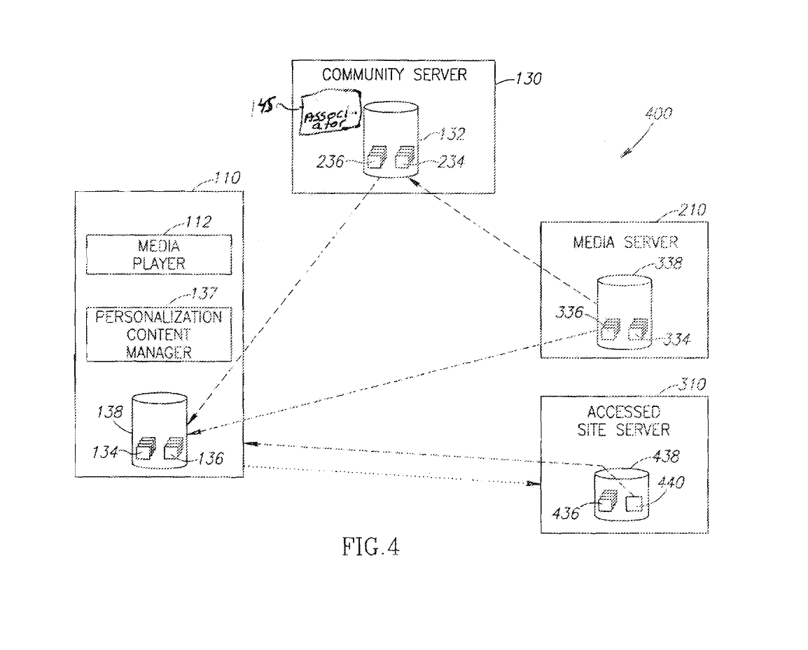

FIG. 4, to which reference is now made, illustrates how the present invention may be configured to enable external links. As in the previous embodiments, system 400 may comprise a community server 130, a communications device 110 and a media server 210, where similar reference numerals may refer to similar items. System 400 may also comprise an accessed site server 310. Accessed site server 310 may comprise a database 438 storing associated media content 436, and an accessed application 440.

As described hereinabove, media clip 234 may be downloaded to communications device 110 from community server 130 and stored as media clip 134. Alternatively, media clip 334 may also be downloaded either directly or indirectly (via community server 130) from media server 210 and stored as media clip 134. Media player 112 may play media clip 134 in response to a call related activity and a notification including a trigger and/or further access instructions may be displayed on communications device 110.

The trigger may comprise a link to a URL on accessed site server 310. Associated media content 436 may be located at the URL and launched for play on media player 112 when the trigger is activated. Alternatively, associated media content 436 may be downloaded and saved as associated media content 136 in database 138.

Applicants have realized that system 400 may be used to push other types of informational announcements, such as advertising, to the user of communications device 110. In accordance with a preferred embodiment of the present invention, media clip 134 may comprise a short advertisement for a product or service. Associated media content 236, 336 or 436 may be expanded versions of the advertisement, or additional relevant information. In accordance with an alternative embodiment of the present invention, media clip 134 may not comprise any advertising material. However, associated media content 236, 336 or 436 may provide or include advertising material for products or services that may be associated with the content of media clip 134.

The trigger may also be used to link to non-media content as well. In accordance with an alternative preferred embodiment of the present invention, the link may launch accessed application 440. Accessed application 440 may be downloaded to communications device 110 or accessed directly via the Internet. Accessed application 440 may be a computer application that may be of interest to the owner of communications device 110. For example, accessed application 440 may be a purchasing application to buy media content and/or other goods and services via the Internet. Furthermore, accessed application 440 may also be any kind of computer software distributed for commercial or promotional uses.

As disclosed in U.S. patent application Ser. No. 11/544,938, call-related media content may comprise video clips, images, audio clips, programs, and invocations of a program. Accordingly, it will be appreciated that the embodiments of the present invention described hereinabove may also be implemented using any of the abovementioned media instead of, or in addition to, media clips 134.

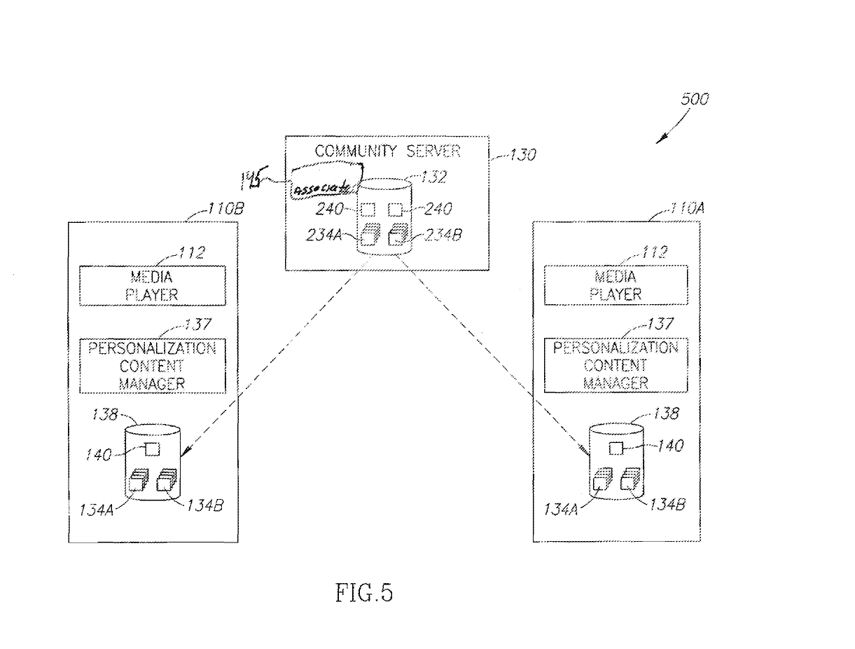

Applicants have also realized that the present invention may also be used to disseminate and/or implement games. FIG. 5, to which reference is now made, illustrates how the present invention may be configured to provide a framework for the delivery and/or playing of single player or multi player games. As in the previous embodiments, system 500 may comprise a community server 130, and one or more communications device 110. Similar reference numerals may refer to similar items.

In accordance with a preferred embodiment of the present invention, a user may select two media clips 234 (A and B) from community selection database 130 to be downloaded as media clips 134A and 134B to a buddy's communications device 110B. Media clips 134A and 134B may together present a challenge puzzle or riddle to the buddy. Media clip 134A may present the challenge and media clip 134B may refresh the question and prompt for an answer.

When the user and buddy begin a phone conversation media player 112 may play media clip 134A on communications device 110B. Media player may also play media clip 134B when the phone conversation ends. The buddy may then attempt to solve the puzzle or riddle by speaking or typing the answer. The answer may be checked locally by a grading function on communications device 110B or it may be transmitted to community server 130 to be evaluated.

It will be appreciated that the buddy may ask for help from the user (i.e. the person with whom he is chatting). However, because the buddy is in the middle of a phone conversation, it may be difficult to ask for help from anyone else.

In accordance with an alternative preferred embodiment of the present invention, media clips 234 may also be downloaded to the user as well as to the buddy. For example, the user may use communications device 110A while the buddy may use communications device 110B. Copies of media clips 234A and 234B may be downloaded and then played on both devices 110 when the user and buddy have a phone conversation. The user and the buddy may then both attempt to solve the riddle or puzzle.

It will be appreciated that the user may also select only a single media clip 234 for the game. The answer may then be solicited during or at the end of playing local copy media clip 134. When only a single media clip 134 is so used, it may be played at the beginning or end of the conversation.

It will further be appreciated that in addition to selecting media clips 234 from database 132, the user may also upload media clips 234 from an external source or subscribe to a service which may change them periodically, as described hereinabove.

Applicants have realized that using system 500 to disseminate and facilitate game applications may provide a richer game experience. A user may select a game application 240 from database 132. Game application 240 may be downloaded to communications devices 110A and 110B and stored as application 140 in buddy media clip databases 138. Whenever the user and buddy have a phone conversation, each personal content manager 137 may launch application 140 on each device 110.

Communications devices 110 may be capable of providing simultaneous voice and data transfer. For example, many newer “3G” phones have such capabilities. If such capabilities exist on both communications devices 110, applications 140 may send game data between devices 110 used by the players (i.e. the user and the buddy). The players may discuss the game over a voice channel while applications 140 use a data channel. Multiple players may play the game together over combined voice and data channels.

The two users may still share a game while using communications devices 110 without simultaneous voice and data transfer. The ongoing voice call may be an enabling mechanism to facilitate running the game. Each player may play a “solitaire”-like game. Alternatively, they may play a multi-player game, using the voice channel to inform each other as they make a move.

It will be appreciated that by implementing such games via voice channels, existing mechanisms of billing for voice calls may be used to charge for game use.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
playing a media clip in association with call-related activities;
notifying a user that associated media content is available; and
enabling said user to play said associated media content.

2. The method according to claim 1 and also comprising downloading said associated media content prior to said playing of said media content.

3. The method according to claim 1 and also comprising downloading said associated media content after said notifying.

4. The method according to claim 1 and wherein said notifying comprises at least one of the following: sending an email, sending an SMS, sending an MMS, sending a message, invoking a dedicated application, displaying text, and playing another media clip.

5. The method according to claim 1 and wherein said enabling comprises providing a user interface element to play said associated mobile content.

6. The method according to claim 5 and wherein said user interface element is embedded within said media clip.

7. The method according to claim 1 and wherein said enabling comprises providing instructions how to play said associated media content.

8. The method according to claim 1 and wherein said enabling comprises providing means to play said associated mobile content following said playing of said media clip.

9. The method according to claim 1 and wherein said enabling comprises providing means to access and play said associated mobile content at a later time.

10. The method according to claim 1 and also comprising providing means to access and play said media clip at a later time.

11. The method according to claim 1 and wherein said associated media content is from a subscription service.

12. The method according to claim 1 and wherein said associated media content is from a different source than said media content.

13. The method according to claim 1 and wherein said associated media content is an advertisement.

14. The method according to claim 1 and wherein said associated media content is a news report.

15. The method according to claim 1 and wherein said associated media content is a game.

16. A system comprising:
a community server to store media clips for playing on communications devices on the occasions of call related activity;
an associator to store associations of said media clips with media content;
a downloader to provide said associations and said media clips to said communications devices.

17. The system according to claim 16 and wherein said downloader comprises means for downloading said associated content.

18. The system according to claim 16 and wherein said downloader comprises means for providing a reference from which said associated media content can be accessed.

19. The system according to claim 16 and wherein said media clips are advertisements.

20. The system according to claim 16 and wherein said media clips are news reports.

21. The system according to claim 16 and wherein said media clips are games.

22. A method comprising:
storing an informational announcement on mobile devices; and
activating said informational announcement in association with call-related activities.

23. The method according to claim 22 and wherein said informational announcement is an advertisement.

24. The method according to claim 22 and wherein said informational announcement is a news report.

25. The method according to claim 22 and also comprising notifying a user that media content associated with said informational announcement is available.

26. The method according to claim 22 and wherein said informational announcement comprises at least one of: a media clip, a text message, an MMS, an application and a hyperlink.

27. The method according to claim 25 and also comprising downloading said associated media content prior to said activating.

28. The method according to claim 25 and also comprising downloading said associated media content subsequent to said activating.

29. The method according to claim 25 and also comprising enabling said user to play said associated media content.

30. A method comprising:
providing a game to mobile devices; and
activating said game in association with call-related activities.

31. The method according to claim 30 and wherein said game is at least one of: a media clip, an MMS, a text message and a game application.

32. The method according to claim 30 and wherein said game is a single player game.

33. The method according to claim 30 and wherein said game is a multiplayer game.

34. The method according to claim 33 and also comprising:
using a data channel to exchange game data between players of said multiplayer game; and
enabling said players to converse over a voice channel.

35. The method according to claim 33 and also comprising:
using a standalone version of said multiplayer game for each player; and
enabling said players to converse over a voice channel.

36. A system comprising:
a media player to play at least one media clip in response to call-related activity between a user and a buddy;
a notifier to notify said user that media content associated with said media clip is available.

37. The system according to claim 36 and also comprising a downloader to download said media clips and said associated media content.

38. The system according to claim 36 and wherein said media player also plays said associated media content.

39. The system according to claim 36 and also comprising a personalization content manager to access said media clip and said associated media content.
